(19) United States
(12) Patent Application Publication
(10) Pub. No.: US 2025/0102665 A1
(43) Pub. Date: Mar. 27, 2025

(54) ESTIMATING RFID TAG LOCATIONS FROM MULTIPLE DATA INPUTS

(71) Applicant: Automaton, Inc., San Diego, CA (US)

(72) Inventors: Debarun Dhar, New York, NY (US); Joe Mueller, San Diego, CA (US); Prokopios Panagiotou, Seal Beach, CA (US); Melissa Swats, Boca Raton, FL (US); Spencer Hewett, New York, NY (US); Paul Petrus, San Jose, CA (US)

(73) Assignee: Automaton, Inc., San Diego, CA (US)

(21) Appl. No.: 18/974,612

(22) Filed: Dec. 9, 2024

Related U.S. Application Data
(63) Continuation of application No. PCT/US2023/038318, filed on Jun. 12, 2023.

(51) Int. Cl. G01S 13/87

(52) U.S. Cl. CPC G01S 13/878

(57) ABSTRACT

Methods and apparatus for estimating RFID tag locations in multipath environments are described. A plurality of RFID readers, sparsely placed reference tags, and constructed signal vectors can be used to estimate the location of RFID tags in a multipath environment.

### CROSS-REFERENCE TO RELATED APPLICATION(S)

This application is a bypass continuation of International Application No. PCT/US2023/068318, filed on Jun. 12, 2023, which claims the priority benefit, under 35 U.S.C. 119 (e), of U.S. Application No. 63/351,171, filed on Jun. 10, 2022, which is incorporated herein by reference in its entirety for all purposes.

### BACKGROUND

Radio-frequency identification (RFID) tags are low-cost devices that can be attached to objects and offer the promise of automated locating, tracking, sales check-out, and inventory among other commercial and medical applications. There are passive, semi-active, and active types of RFID tags that can be wirelessly interrogated by an RFID reader, also called an RFID tag reader, reader, or sensor, and emit a wireless radio frequency (RF) reply that includes information stored in the RFID tag, such as a tag identification number and electronic product code (EPC). Other information may be included with the reply.

Passive RFID tags have no battery and are therefore typically less expensive than semi-active and active RFID tags, which can include a battery. Passive RFID tags essentially absorb enough energy from an RF interrogation pulse sent by the RFID reader to backscatter the RF reply. Although lower cost (e.g., on the order of 1/10th the cost of an active tag), reply signals from passive RFID tags are generally weaker than replies from semi-active or active tags. As a result, the read range of a passive RFID tag can be significantly shorter than the read range of an active tag. For example, the read range of a passive tag may be limited to 100 meters in a line-of-sight environment where there are no intervening objects to obstruct the interrogation and reply signals, whereas the read range of an active tag may be over 500 meters in the same environment.

When RFID tags are deployed in a multipath environment, it can be difficult to estimate the location of each tag with accuracy. FIG. 1A depicts a line-of-sight (LOS) multipath environment 100 in which there are objects (floor, walls, ceiling, furnishings, etc.) that can reflect and/or scatter the reply signal from an RFID tag 101. The RFID reader 150 may receive a plurality of signals from the tag 101 that traverse multiple signal paths 141-145. In the simple illustration of FIG. 1A, the multipath environment 100 contains two walls 110, 112 and a furnishing 120 (e.g., a shelf or file cabinet) that each can reflect at least a portion of the RF reply from the tag 101 to provide a reflected signal path 141, 143, 144, 145. Due to the presence of multiple signal paths 141-145 in a multipath environment 100 (which, in a real-world implementation, can include many more signal paths than those shown in FIG. 1A), estimating the location of an RFID tag 101 accurately is a very difficult task. Conventional advanced approaches that measure angle of arrival (AoA) and received signal strength indication (RSSI) using multiple antennas still are limited in accuracy in multipath environments, and typically cannot locate the RFID tag with an uncertainty less than 1 meter. The problem is exacerbated when there is no direct or line-of-sight (LOS) signal path 142 or a significantly attenuated LOS path (e.g., an intervening object may obstruct signals along the direct signal path 142).

### SUMMARY

The described implementations relate to estimating the locations of RFID tags in line-of-sight (LOS) and non-line-of-sight (NLOS) multipath environments. The RFID tags may densely populate the environment (e.g., at least one RFID tag per cubic meter) and the environment can include a large number of objects (movable and/or fixed) that can reflect and/or obstruct RFID tag replies to interrogation signals. In some cases, the RFID tags are each attached to a different object (e.g., commercial products) and there can be up to 100 such product RFID tags or more per cubic meter.

Apparatus to locate RFID tags can include a plurality of RF sensors located in the environment and may further include sparsely placed reference RFID tags (e.g., less than one reference tag per cubic meter). A tag-locating system that includes at least one processor can receive signals from the plurality of RF sensors and generate data inputs that are processed using one or more methods to determine tag locations. At least some of the data inputs may be used to form tag signatures or signal vectors for each RFID tag. Each signal vector can include a variety of information or features obtained from one or more measurements relating to an RFID tag. The signal vectors can be analyzed (e.g., compared to reference vectors obtained from the reference tags) to estimate the location of RFID tags with uncertainties (one standard deviation) less than 1 meter. An RFID tag that is closer to a reference RFID tag can be located with higher accuracy (smaller uncertainty) than an RFID tag located farther from the reference tag. For example, an RFID tag having the same antenna orientation as that of a reference RFID tag and located within 10 cm of the reference tag may be located with an uncertainty less than 2 centimeters.

Some implementations relate to a method for locating a first radio-frequency identification (RFID) tag in a multipath environment. The method can include acts of: receiving, by a first RFID reader located at a first position in the multipath environment, a first plurality of signals from the first RFID tag, wherein the first plurality of signals result from a reply signal sent in response to an interrogation of the first RFID tag and are representative of the multipath environment; constructing, by a processor in communication with the first RFID reader, a first signal vector that is based, at least in part, on the first plurality of signals and that contains features representative of and/or derived from the first plurality of signals; providing the first signal vector as input to a machine learning process that executes on the processor, wherein the machine learning process is trained with input from reference vectors constructed from a second plurality of signals received from RFID reference tags distributed in the multipath environment; estimating, with the machine learning process from the features in the first signal vector, a first location of the first RFID tag in the multipath environment; and outputting from the machine learning process the estimated first location of the first RFID tag.

Some implementations relate to a tag-locating system. The tag-locating system can include a plurality of RFID readers adapted to be mounted at a plurality of locations in a multipath environment containing a plurality of RFID tags and adapted to interrogate each of the plurality of RFID tags. The tag-locating system can further include one or more cameras, each arranged to capture images of at least portions of the multipath environment, and a processor in communication with the plurality of RFID readers and the one or more cameras. The processor is adapted to execute a machine learning process to estimate a first location of a first RFID tag of the plurality of RFID tags within the multipath environment. The processor, when operating, is adapted with code to: receive, from a first RFID reader of the plurality of RFID readers, a first plurality of signals from the first RFID tag, wherein the first plurality of signals result from a reply signal sent in response to an interrogation of the first RFID tag and are representative of the multipath environment; construct a first signal vector that is based, at least in part, on the first plurality of signals and that contains features representative of and/or derived from the first plurality of signals; provide the first signal vector as input to the machine learning process, wherein the machine learning process is trained with input from reference vectors constructed from a second plurality of signals received from RFID reference tags distributed in the multipath environment estimate, with the machine learning process from the features in the first signal vector, the first location of the first RFID tag in the multipath environment; and output from the machine learning process the estimated first location of the first RFID tag.

Yet another embodiment includes a method for locating a first RFID tag (e.g., attached to a commercial product for product identification and/or product tracking) in a multipath environment. This method includes receiving, by an RFID reader located at a first position in the multipath environment, a reply signal by the first RFID tag that is sent in response to an interrogation of the first RFID tag and is representative of the multipath environment. The method also includes obtaining a representation of the multipath environment, such as an image or lidar scan. A processor in communication with the first RFID reader constructs a signal vector based, at least in part, on the reply signal and the representation of the multipath environment and provides the signal vector as input to a machine learning process that executes on the processor. This machine learning process is trained with reference signals received from RFID reference tags and at least one previously obtained representation of the multipath environment. The machine learning process estimates, based on the input, and outputs a location of the first RFID tag in the multipath environment.

The signal vector can include at least one element based on information derived from in-phase and in-quadrature waveforms obtained from the reply signal received by the first RFID reader. It can also include at least one element based on information derived from a multipath angular signal profile. And/or it can include at least one element based on received signal strength or differential phase delay of a radio-frequency carrier wave of the reply signal.

In some cases, the location is a first location, and the processor determines an angle of arrival (AoA) of the reply signal at the first RFID reader. A second RFID reader located at a second position in the multipath environment detects the reply signal sent by the first RFID tag in response to the interrogation of the first RFID tag. The processor determines an AoA of the reply signal at the second RFID reader and estimates a second location of the first RFID tag using the AoAs of the reply signal at the first and second RFID readers. The processor estimates a third location of the first RFID tag is based on the first and second locations and outputs the third location as an estimated location of the first RFID tag.

The processor can identify a region in the multipath environment where the first RFID tag can be located and reject an estimated location of the first RFID tag that falls outside that region.

The processor can also identify an excluded region in the multipath environment where the first RFID tag is not (or cannot be) located and rejected an estimated location of the first RFID tag that falls within the excluded region. In some cases, the processor can analyze the representation of the multipath environment to identify the excluded region as a region where an RFID tag cannot be physically located. The processor can also analyze the representation of the multipath environment to identify the excluded region as an aisle or open space where RFID tags are not normally located. If the location of the first RFID tag falls within the excluded region, the processor can analyze an image of the excluded region captured concurrently with the reply to determine whether a person, cart, or machine that can transport the first RFID tag is present at the excluded region. If so, the processor outputs the location of the first RFID tag in response to determining that the person, cart, or machine is present at the excluded region.

In some cases, the RFID reader is a first RFID reader that listens for the reply signal and a second RFID reader spaced apart from the first RFID reader performs the interrogation of the first RFID tag.

If the processor receives or derives an actual location of the first RFID tag, e.g., based on an image, the processor can tune the machine learning process using the input and the actual location of the first RFID tag. The input to the machine learning process can also be based on the reply signal as detected by a second RFID reader located at a second position in the multipath environment.

The processor can analyze one or more images of the multipath environment to determine whether a furnishing supporting the first RFID tag has been moved within the multipath environment, determine a new location and/or orientation of the furnishing from the image(s), and tune the machine learning process based on the image(s) in response to determining the new location and the orientation of the furnishing. The machine learning process can also trained by distributing the RFID reference tags in known locations in a training environment, receiving the reference signals from the RFID reference tags, and training the machine learning process with the reference signals before deploying the machine learning process to the multipath environment.

Still another method for locating an tag in a multipath environment includes receiving, by an n-element antenna array, a reply from the RFID tag, where n is an integer greater than 1. A processor in communication with the n-element antenna array constructs a signal vector based on the reply from the RFID tag. The signal vector can comprise n complex numbers, each of which represents an estimate of a communications channel between the RFID tag and a corresponding antenna element in the n-element antenna array. A camera operably coupled to the processor obtains an image of the multipath environment. The processor provides the signal vector and image as input to a machine learning model executing on the processor. This machine learning model is trained with reference vectors constructed from reference signals received from RFID reference tags at respective known locations. The machine learning model estimates and a location of the RFID tag in the multipath environment based on the signal vector and the image and outputs the location.

The RFID tag can be a first RFID tag and the signal vector can be a first signal vector, in which case the camera can obtain an image of a second RFID tag. The processor determines a location of the second RFID tag from the image of the second RFID tag. The n-element antenna array receives a reply from the second RFID tag, and the processor constructs a second signal vector based on the reply from the second RFID tag. The processor tunes the machine learning model based on the second signal vector and the location of the second RFID tag.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1A depicts a multipath, line-of-sight (LOS) environment.

FIG. 1B depicts a multipath, non-line-of-sight (NLOS) environment.

FIG. 2 depicts an RFID reader having multiple antenna elements that may be used in the multipath environments of FIG. 1A and FIG. 1B and that can measure signal strength as a function of receive angle.

FIG. 3A illustrates an example of a multipath angular signal profile that may be obtained with the RFID reader of FIG. 2.

FIG. 3B illustrates another example of a multipath angular signal profile that may be obtained with the RFID reader of FIG. 2.

FIG. 4 depicts a multipath, non-line-of-sight (NLOS) environment that includes readers, cameras, and temporary and/or virtual reference tags to provide additional data for identifying locations of RFID tags with an artificial neural network or other machine learning model executing on an appliance.

FIG. 5A and FIG. 5B depict waveforms that may be correlated to obtain features for signal vectors.

FIG. 6 illustrates a process for training, tuning, and using an artificial neural network or other machine learning model to locate RFID tags in a multipath environment from replies and representations about the multipath environment.

### DETAILED DESCRIPTION

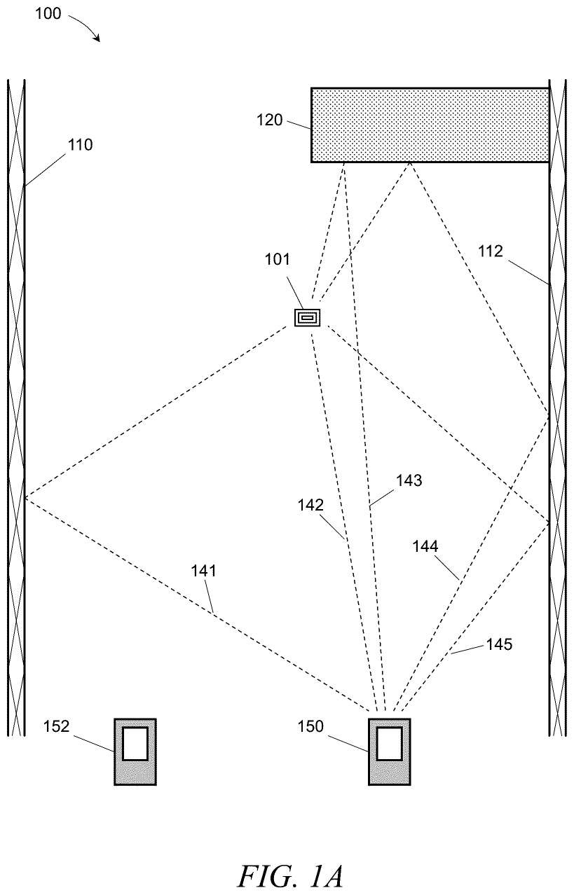

FIG. 1A depicts a LOS multipath environment 100, as described above, in which there can be one or more RFID tags 101 (only one is shown to simplify the illustration). The environment is considered a LOS environment since there is nothing to obstruct the RF signals proceeding along the direct signal path 142 between the RFID tag 101 and the tag reader 150. The environment is also considered a multipath environment since the RF signals can take multiple signal paths 141-145—including the direct signal path 142 and signal paths 141, 143-145 with reflections off other surfaces—between the RFID tag 101 and the tag reader 150.

In the simple LOS multipath environment 100, a combination of data inputs may be sufficient to determine the tag's location with a single RFID reader 150 or two RFID readers. For example, data from angle of arrival (AoA), received signal strength indicator (RSSI), and/or ranging measurements (e.g., based on time of arrival or delay in the tag's RF reply signal, time of flight (ToF), or phase shift of the reflected carrier wave) may be sufficient to determine tag location with reasonable accuracy (e.g., down to about 1 meter or less in a simple LOS environment). Triangulation and/or trilateration may be used with such data inputs to determine tag location.

FIG. 1B depicts a multipath, non-line-of-sight (NLOS) environment 105 in which an intervening signal-obstructing object 160 inhibits LOS communication with the RFID tag 101. The object 160 may reflect, block, or significantly attenuate the reply signal from the RFID tag 101 that would otherwise travel unobstructed along the LOS signal path 142. The object 160 may be anything that reflects, blocks, or attenuates an RF signal. Example objects include, but are not limited to, the back or top of a shelf in which the RFID tag sits, the object to which the RFID tag is attached (such as an appliance or consumer-electronic device containing metal), a furnishing, a person, a cart, a machine, etc.

In practice, there can be many RFID tags (hundreds or thousands) and many objects in a multipath environment that should be located with accuracies down to 1 meter or less. Each tag to be located may be singulated from other RFID tags in the environment such that it is the only tag issuing a reply to an interrogation by the reader 150. The process of tag singulation is known to those skilled in the field of RFID tags. The added tags and objects may interfere with RF signals and add more signal paths. Additionally, some of the tags may not have a direct signal path to an RFID reader due to the added objects and tags. Accordingly, it can become increasingly difficult or impossible to determine tag location for all tags with an accuracy of less than 2 meters using data inputs from AoA, RSSI, and ranging measurements as described above. Additional data inputs and tag-locating methods can improve the accuracy with which tags are located.

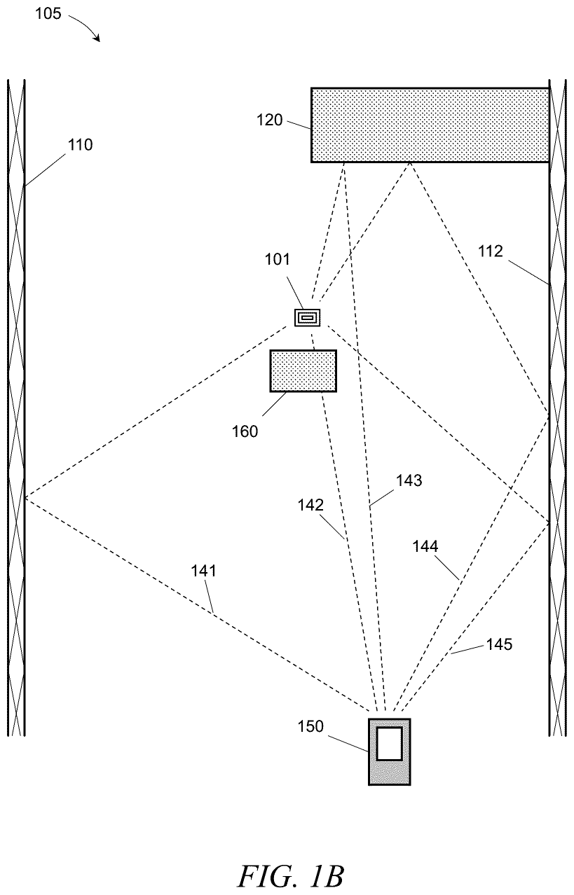

One example of additional data input is a multipath angular signal profile. FIG. 2 depicts a simplified example of a phase-programmable linear antenna array 200 that can be used to measure a multipath angular signal profile for a singulated RFID tag. The RFID reader 150 can include an antenna array 200 having multiple antenna elements 210 (separated in one, two, or three dimensions). The antenna elements 210 can be phase programmed to define a receive angle for the antenna array. The example shows four antenna elements 210 in the antenna array 200 and each antenna element is separated by one-half the wavelength of a carrier wave (wavelength λ) that is used by the RFID reader to communicate with the RFID tags. In other examples, the antenna elements may be separated by more than λ/2 to reduce cross-talk and increase isolation as disclosed in International Application No. PCT/US2022/081761 titled “Antenna Arrays and Signal Processing for RFID Tag Readers,” filed Dec. 16, 2022, which application is incorporated herein by reference in its entirety.

Each antenna element 210 can detect an RF signal backscattered from an RFID tag and provide a corresponding analog signal to the reader 150 for processing. For the first RFID tag 101a located in front of the antenna array 200, the reply RF wave 220 strikes each antenna element 210 in the array 200 with nearly equal phases. Programmable phase delays in each signal path from an antenna element and the reader's signal processing circuitry can be set (e.g., zero phase offset between each antenna element) such that the analog signals from each antenna element add constructively at the reader 150. For the second RFID tag 101b, the signals from adjacent antenna elements 210 in the array 200 are shifted by approximately one-half wavelength in phase (for the same programmable phase delays) and therefore essentially cancel to filter out signals coming from the sides of the array 200.

With more antenna elements 210 and setting programmable phase delays between antenna elements to selected values, the receiving direction of the antenna array 200 can be spatially narrowed (providing better filtering for off-axis signals and improving angular resolution of the antenna array 200). Further, by programming phase delays between the antenna elements to different values, the receiving direction can be steered or pointed without physically rotating the antenna array. This can be crudely understood by programming a half-wavelength phase delay between adjacent antenna elements in the illustrated example. In that case, the signals received from antenna elements for the second RFID tag 101b, add constructively at the reader 150, whereas the signals received from antenna elements for the first RFID tag 101a add destructively at the reader 150.

In some cases, the antenna array 200 may be physically rotated to steer or point the receive angle for the array. In some implementations, the antenna array 200 may comprise one or a few antenna elements 210 that are physically moved back-and-forth or in some other cyclic pattern to emulate an antenna array having more antenna elements 210. Such implementations may be referred to as synthetic aperture (SA) antenna arrays.

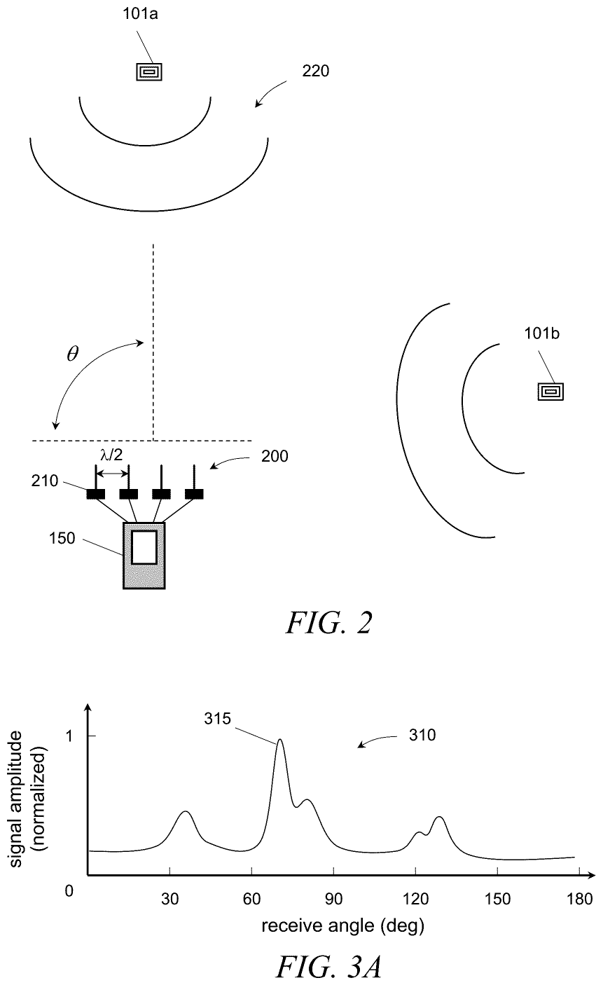

By measuring RF reply signals as a function of the receive angle θ in a multipath environment, a multipath angular signal profile 310 may be obtained. FIG. 3A illustrates a multipath angular signal profile 310 that may be obtained by the RFID reader 150 for the multipath environment 100 of FIG. 1A using an antenna array or SA antenna array. The signal profile 310 exhibits five peaks indicative of the AoA of the five signal paths 141-145.

The multipath angular signal profile 310 can be used to estimate the location of the RFID tag 101. Because each reflection of the RF reply signal may attenuate the RF reply signal, the dominant peak 315 may correspond to the direct signal path 142 in the LOS multipath environment 100. Accordingly, data inputs of signal strength (to select the dominant peak) and multipath angular signal profile 310 can identify the direction of the RFID tag 101 with reasonable accuracy in the LOS environment 100. Additional data input is needed to determine the distance and/or location from the RFID reader. In some cases, the RFID reader 150 may be configured to determine the distance or range of the tag 101 from the reader as mentioned above. Distance or range may be determined by analyzing the delay time between interrogating the tag and receiving a reply from the tag and/or by analyzing received signal strength. Additionally, or alternatively, the reader 150 may use multi-frequency communication techniques and/or analyze phases of reply signals to determine tag distance. Once angle and distance are known, tag location can be determined by the reader 150 with reasonable accuracy (e.g., less than 50 cm) in a LOS multipath environment 100 that is not densely populated with reflecting objects.

Another approach to determining tag location can employ at least a second RFID reader 152 located in the multipath environment. If the second reader 152 collects only a multipath angular signal profile 310, then triangulation may be used to estimate the location of the RFID tag 101. If the second reader 152 collects only distance information, then trilateration may be used to estimate the location of the tag. Accordingly, a combination of data inputs from one or more RFID readers can be used to determine tag location in a LOS multipath environment 100.

FIG. 3B illustrates a corresponding multipath angular signal profile 310 for the NLOS multipath environment 105 of FIG. 1B. Because of the signal-obstructing object 160, the dominant peak 315 does not indicate the LOS direction for the RFID tag 101. There may or may not be a peak in the signal profile 310 that would correspond to the direct LOS signal path 142. The inventors have recognized and appreciated that determining the correct location of an RFID tag in a NLOS environment that is densely populated with signal-obstructing objects and RFID tags is a challenging problem.

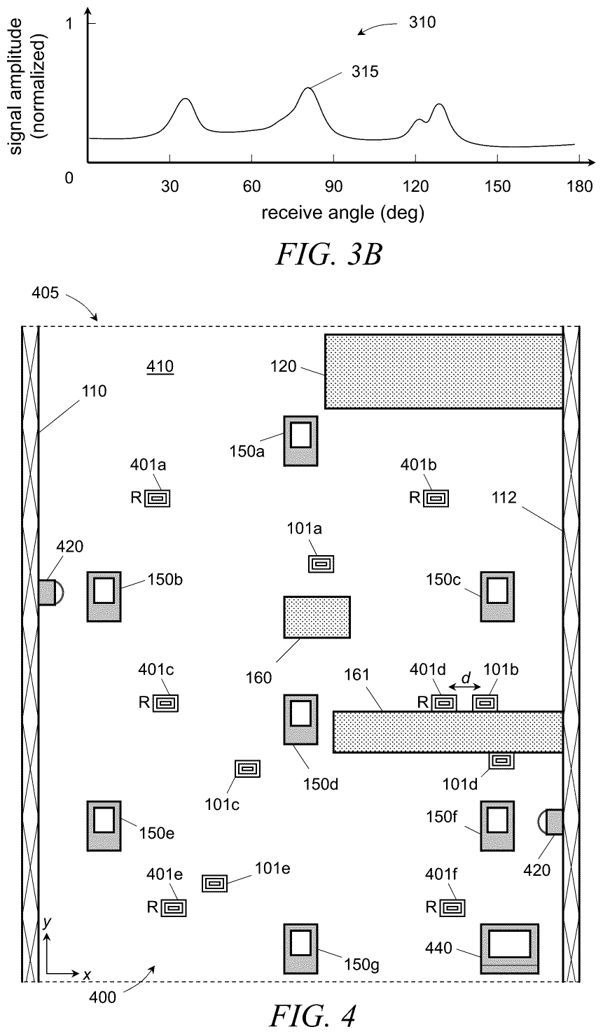

FIG. 4 depicts a NLOS multipath environment 405 that includes an RFID tag-locating system 400 for determining tag locations. The tag-locating system can comprise a plurality of RFID readers 150a-150g and a plurality of reference RFID tags 401a-401f. In some cases, the tag-locating system can include one or more cameras 420. The RFID readers and cameras can be in communication with an appliance 440, also called a controller or central controller. The appliance 440 can include at least one multiprocessing chip, one or more field programmable gate arrays, one or more digital signal processors, one or more application-specific integrated circuits, logic circuitry, or some combination thereof, as well as non-volatile and volatile memory and a communications interface for communicating with the RFID readers 150 and cameras 420 as well as with other network-enabled devices.

There can be a plurality of RFID tags 101a, 101b, etc. attached to objects that are located within the multipath environment 405. The multipath environment may comprise one or more unit cells 410, each having a volume which may be measured in terms of cubic feet or cubic meters. There may be a positive integer number N of the RFID readers 150 distributed in the unit cell 410 and a positive integer number M of reference tags 401 placed in the unit cell 410 for a period of time or permanently to train the tag-locating system 400. The RFID readers 150 from one unit cell 410 may communicate with each other and with the appliance 440 over wired or wireless links (e.g., Ethernet connections), such that the appliance 440 can receive data from and transmit instructions to each RFID reader 150. In some implementations, RFID readers 150 from multiple unit cells 410 may communicate with a common central appliance 440. There may be a plurality of signal-obstructing objects 160, 161 and any number of RFID tags 101a, 101b, etc. located in each unit cell 410.

Each unit cell 410 in the NLOS multipath environment 405 may or may not be bounded, at least in part, by one or more physical structures, such as a floor, wall, ceiling, or some combination thereof. In a large warehouse or store, a unit cell 410 may comprise a sub-region of a large room that includes a number of isles. A unit cell may be relatively small in size (e.g., as small or smaller than a small shop measuring 2 m width×2.5 m height×5 m length) or large in size (e.g., as large as 10 m width×6 m height×20 m length). Larger unit cell dimensions are also possible. There may be up to tens or hundreds of unit cells in a facility. In some implementations, a facility may have only one unit cell that spans the entire facility.

The RFID readers 150 may be distributed across the unit cell 410 at different locations. In some implementations, the RFID readers 150 may be mounted to a ceiling or rafters at or near the top of a unit cell, though the locations of the RFID readers are not so limited. In some cases, the RFID readers may mount to walls 110, 112, floor, ceiling, rafters, furnishings, or some combination thereof in a unit cell 410. There may be a density D_{rd} of RFID tag readers 150 in each unit cell (e.g., number per unit volume). The density D_{rd} of RFID readers 150 may have a value from 0.001 m⁻³ to 0.1 m⁻³. In some implementations, the density D_{rd} of RFID readers 150 may have a value in the range from 0.005 m⁻³ to 0.05 m⁻³. Each RFID reader 150 may have one or more antenna elements 210. When each reader 150 is equipped with only a signal antenna element, a group of readers 150 may be operated together as an antenna array to measure AoA and/or multipath angular signal profile 310 of an RFID reply signal.

Each RFID reader 150 may individually singulate an RFID tag 101a or reference tag 401a, interrogate the tag, and receive an RFID reply from the tag. After one of the RFID readers singulates a tag in interrogation mode, one or more of the other RFID readers 150, operating in listening mode only, can receive a version of the RFID reply from the tag that is indicative of the multipath signal trajectories from the tag to the particular RFID reader 150. As such, the RFID readers may receive different reply signals from the same tag following an interrogation by one of the RFID readers. After receiving a reply signal from an interrogated tag, each RFID reader 150 may transmit the reply signal (and/or results from processing the reply signal) to the appliance 440 for further signal processing. Further description of multiple RFID readers operating in listener mode following interrogation of a tag by one reader can be found in International Application No. PCT/US2022/026198 titled “RFID Tag Readers Switchable Between Interrogator and Listener Modes,” filed Apr. 25, 2022, which application is incorporated herein by reference in its entirety.

One advantage of an RFID reader 150 operating in listener mode only (without issuing an interrogation signal) is that the reader does not have to perform self-interference signal cancellation of its interrogation signal that might otherwise cross couple into its receive signal path. Accordingly, the signal-to-noise ratio (SNR) and sensitivity of an RFID reader 150 operating in listener mode only can be significantly improved compared to an RFID reader 150 that interrogates and then listens for a tag response. Further description of self-interference signal cancellation appears in International Application No. PCT/US2022/035646 titled “Self-Interference Cancellation for RFID Tag Readers,” filed Jun. 30, 2022, which application is incorporated herein by reference in its entirety.

The reference RFID tags 401 may be the same type of RFID tag as the RFID tags 101 that are attached to objects for purposes of tracking or taking inventory of the objects or a different type of RFID tag. The objects to which the RFID tags 101 are attached are not shown in the drawings to simplify the illustrations. The reference RFID tags 401 may be placed in the unit cell 410 at known locations temporarily or permanently to train the tag-locating system 400. In some implementations, the reference RFID tags 401 may be virtual tags as described in U.S. Pat. No. 11,215,691 titled, “Methods and Apparatus for Locating RFID Tags,” issued Jan. 4, 2022, which patent is incorporated by reference in its entirety.

The reference tags 401 can be affixed to furnishings, for example, while training the tag-locating system and may be subsequently removed. In some cases, the reference tags 401 may be attached to mobile objects (e.g., carts, moveable furnishings, people) that move within the unit cell 410. The position of such movable reference tags can be determined from image analysis of images captured by cameras 420 within the unit cell. In some cases, the reference tags 401 may comprise a plurality of the RFID tags 101 that are placed at known locations during the normal course of operation of the facility (e.g., when a commercial product having an RFID tag 101 for product identification or tracking is first stocked or restocked on a shelf at a known location within the facility). That is, no specially-designated reference tags 401 are placed in the unit cell nor kept in their original positions. The locations (e.g., x, y, z position within the unit cell, or isle/shelf location) of the reference tags can be known or determined and provided to the appliance 440 for training and signal processing purposes. There may be a density Dᵣₜ of reference RFID tags 401 within the unit cell that may have a value from 0.01 m⁻³ to 100 m⁻³. In some cases, the reference tags 401 (and 101 when used as reference tags) are spaced more than 15 cm apart (e.g., a spacing value between 15 cm and 200 cm) in the unit cell and yet the tag-locating system 400 can estimate the location of any RFID tag in the unit cell (at a previous unknown location) with an accuracy (one standard deviation) of less than one meter. As such, the RFID tag (for which the location is estimated) may be more than 15 cm from a reference tag location.

The RFID tag-locating system 400 may use machine learning models executing on the appliance 440 or another processor operably coupled to the readers 150 to estimate locations of RFID tags 101a, 101b, etc. in NLOS or LOS multipath environments. Suitable machine learning models for locating RFID tags can include unsupervised models, semi-supervised models, and supervised regression models. Most types of machine learning models can work well using regular feature vectors as input; neural networks work well for more complex data representations, such as 3D space models.

Unlike other machine learning methods, a baseline artificial neural network or other machine learning model used by the RFID tag-locating system 400 for executing the machine learning process can be trained before the RFID tag-locating system 400 is deployed to the multipath environment 405, e.g., in a separate training environment with a large number and high density of reference tags (e.g., hundreds to thousands of reference tags) at known locations. Training a baseline machine learning model in a well-controlled, well-understood training environment allows training and testing data sets with a much higher number and higher density of tags and more unique tag measurements than is practical (or maybe even possible) in the multipath environment itself.

Once the RFID tag-locating system 400 has been deployed, the baseline artificial neural network or other machine learning model employed by the appliance 440 can be updated or tuned using a much smaller number of reference tags (e.g., tens to one hundred reference tags). Training the machine learning model before deployment, then tuning the machine learning model during and/or after deployment reduces the time it takes to install and deploy the RFID tag-locating system 400. It also provides the advantage of potentially much larger, much more diverse sets of training and testing data—and hence much better performance of the location estimation by the machine learning process executed by the appliance.

In addition, the machine learning methods used by the RFID tag-locating system 400 can take a variety of modalities as both training and input data, including replies from the RFID tags 101 as well as information about the multipath environment 405 (e.g., images, lidar scans, and/or floorplans of the multipath environment 405) and information about the readers 150 (e.g., locations, numbers and orientations of beam-forming sectors, etc.). As discussed below, for example, the training and input data may include copies of the same reply from a given RFID tag 101 or reference RFID tag 401 as sensed by different readers 150, one of which interrogates the tag and the other(s) of which simply detect the tag's reply. Representations of the multipath environment 405, such as images acquired by the cameras 420, lidar scans, or floorplans, provide information to the machine learning model about walls, fixtures, and/or other static features of the multipath environment 405.

Images acquired by the cameras 420 provide information to the machine learning model about dynamic features of the multipath environment 405, such as whether or not any people are present and, if so, where they are, their sizes, and their motion. The machine learning model uses these images to account for both the static and dynamic aspects of the multipath environment. Input about static and dynamic aspects of the multipath environment 405 enables the machine learning model to produce more accurate estimates of the locations of the RFID tags 101.

Images can also reveal information about tag density (e.g., by showing many tagged items stacked on top of each other or placed near each other). Tag density affects each tag's response; tags in the middle of a stack of tags may not be activated by interrogation signals or produce detectable responses due to coupling with nearby tags. The machine learning model uses images of densely stacked tags (or tagged objects) to locate tags that might otherwise be difficult or impossible to locate otherwise.

In some cases, the tag-locating system 400 may additionally use methods relating to AoA, RSSI, etc. to aid in determining tag locations. To implement machine learning methods, the tag-locating system may develop signal vectors Vᵢ(Q) for each RFID tag within a unit cell 410. Each signal vector can comprise an integer number Q of features. In some cases, there may be Q=L×P features in a signal vector, where L is a positive integer less than or equal to N (the number of RFID readers in the unit cell 410) and P represents the number of distinct features that can be obtained from one or more measurements by each of the RFID readers. For example, a signal vector may include the normalized channel estimate, which is based the relative magnitude and phase, detected by each of the RFID reader's antenna elements.

In some instances, there may be fewer or more distinct features in a signal vector. Examples of distinct features include, but are not limited to, RSSI, AoA, SNR, temporal signal profile and/or parameterization thereof, multipath angular signal profile 310 and/or parameterization thereof, reply waveform and/or parameterization thereof, and information derived from signal profiles and/or waveforms (e.g., number, locations, and/or amplitudes of peaks and/or minima, differential phase delay Δϕ/Δf of the RF carrier wave). Profiles and waveforms may be processed (e.g., filtered, differentiated, normalized, etc.) to generate additional features. According to some implementations, a signal vector Vᵢ and/or reference vector Vᵣⱼ may be based in part or entirely on an analysis of in-phase and in-quadrature (IQ) waveforms produced by the RFID reader 150 from one or more RF waveforms received by one or more antenna elements 210 of the RFID reader 150. Each IQ pair of waveforms from an antenna element 210 can be processed to produce channel estimate values for the link between the antenna element 210 and the RFID tag 101b or reference tag 401d responding to the RFID reader. Each channel estimate value can be a complex number that represents the communications channel between the corresponding antenna element 210 and the corresponding RFID tag 101b or reference tag 401d and can then be used as features of a signal vector Vᵢ or reference signal vector Vᵣⱼ, respectively. Channel estimates can also be represented as pairs of real numbers as explained below.

For example, an RF waveform received by an antenna element from an RFID tag 101b can be processed and digitally sampled by the RFID reader to produce an IQ pair of digital data streams representative of in-phase and in-quadrature signal components from the RF waveform. The received RF waveform can encode a sequence of +1 and −1 bits (or other digital bits) on a carrier wave. The received RF waveforms may have been transmitted by the RFID tag in response to a query or other command sent by the RFID reader. The sequence of bits can include preamble bits or other known bit sequences (e.g., a previously learned tag identification). Alternatively, or additionally, the sequence of bits can include data payload bits which may be unknown by the RFID reader 150 prior to decoding, but which are accompanied by error-detecting information (e.g., a cyclic redundancy check (CRC) value). In some cases, the IQ data streams can be processed to remove the tag's EPC data or to select a known portion of the tag's reply so that the selected portion of the reply signal from the tag is representative of the same sequence of bits sent by the RFID reader to the tag and can be correlated with the transmitted waveform.

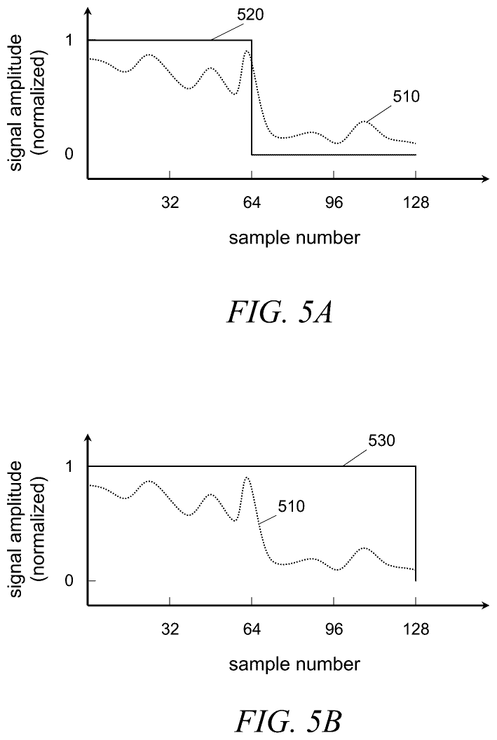

Two similar correlation processes can be performed by the RFID reader 150 or processor 440 for each IQ pair of digital data streams. A first correlation process is performed for the in-phase (I) data stream and a second correlation process is performed for the in-quadrature (Q) data stream. FIG. 5A and FIG. 5B depicts example waveforms that are involved in the correlation processes for both I and Q data streams. For explanation purposes, the example waveforms can be at an intermediate frequency and recovered from the RF carrier wave. In some implementations, the correlations may be performed on RF waveforms that contain the carrier frequency.

Each correlation process can involve correlating (on symbol-by-symbol basis) an interval of the digital data stream 510 with possible corresponding symbol waveforms 520, 530 for that interval. For example, there may be at least two symbol waveforms that are possible. The symbol waveform 520 might be expected for a noise-free and unattenuated waveform encoding a logic 0 bit, and the symbol waveform 530 might be expected for a noise-free and unattenuated waveform encoding a logic 1 bit. The interval of the data stream 510 that will be correlated with symbol waveforms can correspond to a symbol period. Multiple correlations can be performed for each interval of the digital data stream.

To obtain an appropriate time synchronization between the digital data stream 510 and the symbol waveform 520 or 530, several correlations can be performed on one or more symbols in a known symbol sequence (e.g., a preamble data sequence) where the symbol waveform is effectively shifted in time with respect to the digital data stream 510 (e.g., the waveform for the symbol waveform is shifted relative to the sample number). A symbol waveform at a temporal shift that yields the highest correlation (or lowest, or nearest zero, depending on how the correlation is performed) can establish the appropriate time synchronization between the digital data stream and the symbol waveform.

For a known symbol, (only) a corresponding symbol waveform 520 or 530 may be selected for further correlations. For an unknown symbol, both symbol waveforms 520 and 530 can be selected for further correlations. In either case, a plurality of correlations can be performed for each symbol where the amplitudes of the symbol waveforms are varied with each correlation. For known symbols, the correlation having the highest value (or lowest or nearest zero) can identify an amplitude value of the symbol waveform 520 or 530 that best matches the digital data stream 510. The amplitude value is at least indicative of loss in the signal channel between the RFID tag and the antenna element.

For unknown symbols, both symbol waveforms 520 and 530 can be selected for further correlations with the digital data stream 510 using varying amplitudes. The correlation yielding the highest (or lowest or nearest zero) value for a correct symbol can identify an amplitude value of the symbol waveform 520 or 530 that best matches the digital data stream 510. Whether or not the symbol waveform is correct can be determined from error-detection information (e.g., from the CRC value provided with the bit sequence).

In some cases, digital data for an unknown bit sequence transmitted from a tag can be stored for subsequent processing. Signal decoding by the RFID reader 150, using error-detection information and/or error correction techniques, may determine the sequence of bits transmitted by the tag. Once the sequence is known, the correlations using varying amplitude values can be performed using only one symbol waveform per received symbol rather than both symbol waveforms. In some implementations, the correlations may comprise determining a least-squares difference between values of the digital data stream 510 and selected values of the symbol waveform 520, 530. As such, a lowest or nearest zero correlation value, instead of a highest value, may identify a best match between the digital data stream 510 and symbol waveform.

Regardless of how matches are determined, the correlations can yield two channel estimate values for each symbol received from an antenna element. One channel estimate value is determined for the symbol of the in-phase (I) digital data stream and the other channel estimate value is determined for the symbol of the in-quadrature (Q) data stream. In some cases, the two channel estimate values can be expressed as attenuation factors of the received symbols' amplitudes. When multiple symbols in a sequence are processed this way, the channel estimate values can be averaged for each data stream yielding a first average channel estimate value for the I data stream and a second average channel estimate value for the Q data stream, for the antenna element.

With four antenna elements, there can be eight average channel estimate values. These eight average values can be included as feature values in a signal vector Vᵢ (or Vᵣⱼ) associated with the RFID tag (or reference tag) and RFID reader 150 which received the symbol sequences from the RFID tag. Other channel estimate values that may be included as features in the signal vectors include absolute and/or relative shifts in timing of the symbol waveforms 520, 530 between antenna elements. Such features in the signal vector can be influenced, at least in part, by loss in the signal channel between the RFID reader and tag and by the angle of incidence of the antenna elements' received signals.

If desired, the two channel estimate values or average values obtained for the I and Q data streams 510 can be expressed as a complex number. For example, the I average channel estimate value can be the magnitude of the real part of the complex number and the Q average channel estimate value can be the magnitude of the imaginary part of the complex number. Accordingly, for a four-element antenna array, four complex channel estimates may be used as features of the signal vector instead of eight average values. More generally, n complex channel estimates may be used as features of a signal vector for an n-element antenna array, where n is a positive integer.

Signal vectors obtained from reference RFID tags 401a, 401b, 401c, etc. can be used as training input to the tag-locating system 400. Each reference tag can produce a reference signal vector Vᵣⱼ rich with signal information. For example, and referring again to FIG. 4, interrogation of a reference tag 401d by a first RFID tag reader 150a can produce seven sets of signal features, one set from each tag reader 150a-150g, that may be included in a reference vector Vᵣⱼ for the reference tag 401d. Further, interrogation of the same tag 401d by a different tag reader 150b may produce seven additional signal features (e.g., different values of differential phase delay Δϕ/Δf between the second reader 150b and the reference tag 401d) that can be added to a reference vector for the reference tag.

The reference vectors Vᵣⱼ obtained from the reference tags 401 and the corresponding known locations of the reference tags can be used to train a machine learning process that executes on the appliance 440 of the tag-locating system. In the illustrated example, there can be six reference signal vectors that correspond to the six locations of the reference tags 401a-401f. In a practical implementation, there may be more than six reference tags and corresponding known locations that are used to train the machine learning process to locate tags in the unit cell.

In some implementations, the signal features determined from each RFID reader 150a-150g may be used to form seven reference signal vectors Vᵣⱼ₌₁₋₇ or more for each reference tag instead of including all the signal features in a single reference signal vector for each reference tag. As such, there can be more reference signal vectors than there are tags for a unit cell, and a set of signal vectors can be associated with each tag. The machine learning process may then be trained using sets of signal vectors for each reference tag location.

Once the reference signal vectors Vᵣⱼ have been obtained, the reference tags 401 may or may not be removed from the unit cell 410. The system can then estimate the location of other tags 101a, 101b, etc. in the unit cell using the reference signal vectors Vᵣⱼ. For example, one or more of the RFID readers 150a-150g can singulate and interrogate an RFID tag 101b to develop a single signal vector Vᵢ (or up to seven or more signal vectors, one signal vector for each reader) for that tag. Each signal vector and reference signal vector can be thought of as pointing to a location in Q-dimensional space where Q is the number of signal features included in the vectors.

The Euclidean distance(s) D_{E} between the signal vector Vᵢ and one or more of the reference signal vectors Vᵣⱼ (j=1, 2, 3, . . . ) in vector space can be evaluated and quantified to estimate the location of the singulated tag 101b. For a pair of n-element, complex signal vectors representing the amplitudes and phases of the tag reply detected at each element of an n-element antenna array, the Euclidean distance is the length of the line segment separating the points defined by the signal vectors in an n-dimensional space. If one signal vector represents the reply from a reference tag and another signal vector represents the reply from a tag at an unknown position, then the Euclidean distance between the signal vectors in the n-dimensional signal vector space represents the distance between the tags in physical space. By computing the Euclidean distances between a signal vector for a tag at an unknown location and signals vectors for reference tags or other tags at known positions, it is possible to estimate the unknown location relative to the known locations.

If desired, the signal features can be weighted to emphasize some signal features more than others. For example, a signal feature corresponding to RSSI may have a weighted value ranging from 0 to 200 and AoA may have a weighted value ranging from 0 to 360. Other numerical values and ranges may be used for these and other signal features. A signal vector Vᵢ may have an RSSI of 50 and an AoA of 60. A reference vector Vᵣ₃ may have an RSSI of 54 and an AoA of 58. Therefore, the portion of the Euclidean D_{E} distance between these two vectors corresponding to RSSI and AoA would be \sqrt{(50−54)²+(60−58)²}.

For signal profiles (such as those shown in FIG. 3A and FIG. 3B) and temporal waveforms, the magnitude of point-by-point differences may be summed to quantify differences between the overall profiles or waveforms. In some cases, the profiles or waveforms may first be normalized and/or aligned (e.g., using dynamic time warping) before quantifying differences between the waveforms or profiles.

Referring again to FIG. 4, in an example implementation the evaluation of Euclidean distances by the central appliance 440 may reveal that the signal vector Vᵢ for the tag 101b may have a smallest Euclidean distance D_{Ed} from the reference tag 401d compared to the other reference tags. Accordingly, it can be determined that the tag 101b is nearest and within a small spatial distance d from the reference tag 401d. A value for the spatial distance d may be determined by the central appliance 440 based on one or more Euclidean distances between reference tags and their corresponding spatial distances according to the following relation:

$$d = {d}_{r} \frac{{D}_{Ed}}{{D}_{Er}} ,$$

where dr is the spatial distance between the reference tag 401d and a nearest neighbor reference tag 401b or 401f and D_{Er} is a corresponding Euclidean distance between the reference tag 401d and the nearest neighbor reference tag. In some cases, two or more nearest neighbor reference tags and their corresponding Euclidean distances may be used to determine the spatial distance d.

Other approaches for estimating the location of an RFID tag 101b based on Euclidean distance between the tag's signal vector(s) and reference signal vector(s) Vᵣⱼ are also possible. For example, a threshold Euclidean distance Dₜₕ can be selected. If the Euclidean distance calculated between a signal vector Vᵢ of an RFID tag 101b and a reference signal vector Vᵣⱼ of a reference tag 401d is less than the threshold Euclidean distance Dₜₕ, then the location of the reference tag 401d can be output as the estimated location for the RFID tag 101b.

In another approach, the k nearest-neighbor reference tags 401 (where k is a positive integer greater than 1) can be found based on an RFID tag's signal vector(s) Vᵢ and the reference signal vectors. The k nearest-neighbor reference tags can be selected as the k tags having the k smallest Euclidean distances between their reference vector and the RFID tag's signal vector. The estimated location of the RFID tag can then be computed based on the spatial locations of the k nearest-neighbor reference tags 401. For example, the estimated location of the RFID tag 101b can be computed as a three-dimensional weighted average of the spatial locations of the k nearest-neighbor reference tags 401. Higher weights can be given to those reference tags having a smaller Euclidean distance between their reference signal vector Vᵣⱼ and the tag's reference signal vector Vᵢ than such Euclidean distances for other reference tags in the set of k reference tags.

Over time, the machine learning process can be trained with reference signal vectors Vᵣⱼ, using one or more of the above-described processes, to perform regression and output an estimated two or three-dimensional position (or other location metric such as aisle, section, shelf) for each RFID tag 101 being located. In some implementations, the machine learning process can interpolate and/or extrapolate based on training data distributions.

The direction of the RFID tag 101b from the nearest reference tag 401d may be determined from reference signal vectors Vᵣⱼ and/or from selected features from reference signal vectors. For example, a comparison of Euclidean distances from reference tag 401b and tag 101b to nearby reference tags 401b and 401f may reveal that tags 401d and 101b have essentially the same Euclidean distances from the two reference tags 401b and 401f and therefore are located at essentially the same y and z coordinates in the unit cell. A comparison of a Euclidean distance between reference tags 401d and 401c to a Euclidean distance between tag 101b and reference tag 401c may indicate that the tag 101b is located further from reference tag 401c than reference tag 401d, disambiguating the x location of the tag 101b. Alternatively or additionally, the central processor may determine the direction of the tag 101b from the reference tag 401d based on selected signal features such as AoAs and/or multipath angular signal profiles 310. For example, a comparison of the AoAs and/or multipath angular signal profiles 310 obtained by the tag reader 150d for the reference tag 401d and the RFID tag 101b may show essentially the same AoAs and/or multipath angular signal profiles 310, indicating that the RFID tag 101b lies in the same direction (e.g., a same y coordinate) from the reader 150d as the reference tag 401d. A comparison of the AoAs and/or multipath angular signal profiles 310 obtained by the tag reader 150c for the reference tag 401d and the RFID tag 101b may show that the RFID tag 101b lies at a larger x coordinate than the reference tag 401d. Other signal features and/or methods may be used to determine the direction of an RFID tag 101b from a reference tag 401d.

After a number of RFID tag positions have been estimated within the unit cell 410 using reference signal vectors Vᵣⱼ, further training of the tag-locating system may be performed by executing a physical check on some of the estimated tag locations. For example, a user of the system may input to the processor the actual physical location of a random sample of RFID tags 101 distributed in the unit cell 410. The appliance 440 can use the actual physical locations in supervised learning to refine its machine learning process and improve the accuracy with which it estimates tag locations from reference signal vectors Vᵣⱼ. In some implementations, the appliance 440 may perform unsupervised or semi-supervised learning to train the machine learning process.

The actual location of an RFID tag can be obtained and provided to the appliance 440 in any suitable way. For example, a user may operate a hand-held RFID reader to identify RFID tags 101 at random locations within the unit cell 410. The RFID reader may communicate with other RFID readers 150 and/or the appliance 440 to communicate a tag's identification and location to the appliance 440. The location may be input by the user (e.g., row, shelf, section), or may be determined automatically by the hand-held reader or appliance 440 (e.g., using a position tracking device such as an accelerometer, using Bluetooth or WiFi based positioning methods, processing one or more images of the unit cell, or some combination thereof).

Once positions of RFID tags (e.g., tags 101a-101e) have been estimated, the signal vectors Vᵢ for these tags may in turn be used by the central appliance 440 in the machine learning process (or other process executed by the appliance 440) as reference vectors Vᵣⱼ to estimate the location of additional RFID tags within the unit cell. In this manner, a rich library of reference tag data can be accumulated over time by the central appliance 440 as tags are moved into, located, and/or moved within or out of the unit cell.

Another source of reference vectors Vᵣⱼ can be obtained by the appliance 440 based, at least in part, on image processing or computer vision processes. For example, the appliance 440 can process images received from one or more cameras 420 to identify when a tagged object is picked up by an individual and/or placed in a cart or basket. The RFID system may then singulate the attached RFID tag multiple times and receive signal vectors from the tag while visually tracking the tag's movement throughout the multipath environment 405. Each received signal vector can be associated with a position within the multipath environment that is observed by one or more of the cameras 420. For example, a received signal vector Vᵢ can be associated with the location of the individual, cart, or basket transporting the tagged object that is imaged by at least one camera at the time the signal vector is received. Further, the camera(s) may record a final location at which the tagged object is placed to obtain at least one final signal vector and associated location for the RFID tag. The signal vectors Vᵢ (and associated locations determined from image analysis) obtained while the tag is in motion and placed at a final destination can be added to the reference vector Vᵣⱼ library for use as reference vectors.

A reference vector Vᵣⱼ, once determined and recorded by the appliance 440, can be associated with a location (e.g., x, y, z position) within the unit cell rather than associated with an RFID tag. Provided the physical structure of the unit cell 410, location of furnishings 120, and location of other signal-obstructing objects 160 do not change significantly, the accumulated reference vectors Vᵣⱼ can remain as valid reference vectors for determining locations of RFID tags within the environment. In some implementations, the central appliance 440 may analyze images obtained by cameras 420 to determine whether any significant changes have been made to the unit cell 410, furnishings 120, and signal-obstructing objects 160. A significant change may be the addition or removal of one furnishing or other signal-obstructing object or the addition or removal of a wall in the unit cell. A significant change may also be moving one furnishing or other signal-obstructing object by more than 50 centimeters.

Another way to detect whether a significant change has occurred is to re-acquire a signal vector from a reference tag. The re-acquired signal vector Vᵢ should essentially match the previously obtained reference vector Vᵣⱼ for the reference tag. The appliance 440 can compare the two vectors. If there are changes beyond a threshold amount, then the appliance 440 can determine that there has been a significant change to the environment and initiate a process of re-estimating tag locations and/or updating reference vectors Vᵣⱼ.

Upon detection of a significant change within the unit cell 410, the appliance 440 may perform several tasks. The appliance 440 may first determine whether any tags have moved within the unit cell 410 and whether any tags remain in a same position after the significant change in which they were located before the significant change. For example, the appliance 440 may evaluate one or more images from cameras 420 collected before and after the significant change to determine whether a shelf or rack containing tags has moved within the unit cell (e.g., signal-obstructing shelves containing the RFID tags 101b, 101d has moved one meter). The appliance 440 may also determine from the images which tags have not moved despite the significant change. The appliance 440 determines a new reference vector for tags that have not moved and/or updates its machine learning model accordingly. The processor can determine new locations for tags and may obtain new signal vectors Vᵢ for tags that have moved. In some cases, the new signal vectors may subsequently be used as reference vectors.

For tags (reference tags and/or RFID tags) that have not moved, there are at least two ways to obtain updated reference vectors Vᵣⱼ that are representative of the new multipath environment after a significant change. A first way is to simply obtain the reference vectors in the same manner in which the original reference vectors Vᵣⱼ were obtained, by performing RFID read and listening operations as described above and constructing the signal vectors (that can be used as reference vectors since the tags have not moved) based on features of reply signals from tags. Since the tag locations have not changed, the tag-locating system 400 can then be retrained using these new reference vectors Vᵣⱼ.

A second way to update reference vectors Vᵣⱼ for tags that have not moved is to measure signal vectors Vᵢ (using read and listening operations as described above) for a sample number of the fixed or stationary tags that are distributed across the unit cell 410. The sample number may be significantly less than the total number of tags that have not moved (e.g., one-tenth or less of the total number of stationary tags). The appliance 440 may then compare for each sample tag the signal vector Vᵢ obtained for the sample tag after the significant change with the reference vector Vᵣⱼ for the tag that was determined prior to the significant change to quantify how the significant change has altered the reference vector to the new signal vector. Since the change to the reference vector may be systematic (affecting tags in the immediate vicinity of the sample tag in a similar way), the appliance 440 may then apply similar changes to update reference vectors Vᵣⱼ for other tags in the vicinity of the sample tag without performing read and listening operations for the other tags. To improve the accuracy of updating reference vectors Vᵣⱼ, the processor may use interpolation and extrapolation methods for tags located between or beyond the sample tags when constructing updated vectors for the tags. This second way of updating reference vectors Vᵣⱼ can be significantly less time intensive than performing read and listening operations and computing reference vectors Vᵣⱼ from scratch for every stationary tag in the unit cell 410.

In some cases, the tags move in addition to the object(s) in the environment, e.g., in the case of tags on objects that are moved as a group to or with a table, shelf, or other fixture. Determining new positions for tags can be done as described above: acquiring signal vectors Vᵢ for the tags and estimating positions based on reference vectors Vᵣⱼ and corresponding known locations for tags associated with the reference vectors Vᵣⱼ. When a group of tags are moved as a unit, the positions of only two or a few (e.g., less than 10) tags in the group can be estimated by the appliance 440 using signal vector analysis and then the positions of other tags in the group can be estimated using simple geometric calculations and the previous positions of tags that were determined before the group of tags was moved. The use of geometric calculations can be accurate provided the relative positions of the tags in the group have not changed with respect to each other after the move.

Another way to estimate positions of tags that have moved is for the appliance 440 to analyze images obtained from one or more cameras 420. For example, when a furnishing having multiple tags (such as a rack of items each containing a tag) is moved, the new location can be detected by the appliance 440 when analyzing one or more images of the unit cell 410. Detection of such movement can trigger the appliance 440 to perform a re-estimation or updating process to re-estimate at least some tag locations within the unit cell and further to update reference vectors Vᵣⱼ. For the moved furnishing, the appliance 440 can analyze the image to determine a new x, y, z location of the furnishing within the unit cell 410 and an orientation of the furnishing (e.g., a rotation amount from its prior orientation). The appliance 440 can then perform geometric calculations to estimate new positions for the tags based on the new orientation of the furnishing and its new x, y, z location. Such a way to estimate tag positions may not require the acquisition of new signal vectors Vᵢ from the moved tags. Of course, some implementations can use a combination of image analysis and re-acquisition and analysis of signal vectors Vᵢ to estimate new tag locations.

When estimating tag locations according to any of the methods described above, the appliance 440 can be configured to exclude or correct some estimated positions based on processor knowledge about the physical structure of the unit cell 410. Such exclusion and/or correcting of tag locations may implement a process referred to as “boxing.” Knowledge of the physical structure may be gained from the processor's analysis of one or more images of the unit cell. For example, the appliance 440 can analyze the one or more images of the unit cell to identify regions or “boxes” where tags can and/or cannot be located. For example, an excluded region where tags cannot be located may contain x, y, z locations that are: outside the unit cell 410, inside a wall or other supporting structure, within an aisle, etc. A region where tags may be located can be remaining regions in a unit cell 410 or, in some cases, remaining regions between two RFID readers 150. For tag-location computations that result in two or more possible locations of a tag (such as may occur for trilateration calculations), locations that fall within an excluded region (or outside a box where tags can be located) may be ignored or rejected.

The processor may correct an estimated tag location if the estimated location is the only location computed by the appliance 440 and the location falls within an excluded region. The processor may correct the location by changing the computed location to be the nearest location in the unit cell that can be occupied by an RFID tag (e.g., a location falling within a box where tags can be located). If the computed location falls within an aisle or similar open space, the appliance 440 may additionally analyze an image of the unit cell to determine whether an object which can transport the tag (e.g., a person, cart, or machine) is at the computed location. If a tag-transporting object is at the location, the appliance 440 may not correct the tag location.

In a practical environment such as a warehouse or retail store, there can be activity within each unit cell 410. There may be people, machines, carts, and/or automated machines moving objects with RFID tags 101 to and from locations within the unit cell. Additionally, furnishings may be added, moved, or removed from the unit cell. Any of the people, machines, carts, automated machines, and furnishings may be signal-obstructing and therefore dynamically change the multipath environment (and reference vectors Vᵣⱼ) when there is activity within the unit cell.

The appliance 440 can detect activity within the unit cell as described above (e.g., by analyzing images collected by one or more cameras 420 or by detecting changes in one or more reference vectors Vᵣⱼ). In some cases, the appliance 440 may update reference vectors Vᵣⱼ frequently (e.g., every 1 second, 5 seconds, 10 seconds, 30 seconds, 1 minute, or longer intervals). The updating of reference vectors and tag locations (of moved tags) can employ the methods as described above.

In some implementations, the appliance 440 may employ a neural network, such as a convolutional neural network (CNN), or another deep learning model, such as a transformer, to estimate tag locations. A deep learning process is a type of machine learning process that uses layers (e.g., layers in a multi-layer neural network) to train itself over time. The deep learning process can use reply signals from reference tags and/or RFID tags measured by one or more RFID readers 150 as input (e.g., vectors of n complex numbers, where each complex number represents the amplitude and phase of the tag reply detected by a corresponding antenna element on an n-element antenna array at one of the RFID readers 150). The deep learning process may further use signal features such as AoA, delay, RSSI, SNR, etc. as input. Other types of input can include, but are not limited to, raw image data of the multipath environment 405, features extracted from images (e.g., number of people in the environment, number of furnishings and signal-obstructing objects in the environment, locations of people, furnishings, and/or signal-obstructing objects), product density and/or product density maps, a three-dimensional model of the multipath environment, and a depth map of the environment.

Outputs from the deep learning process may comprise estimated locations of RFID tags. In dynamic environments, the deep learning process may also use data obtained from analyzing images of the unit cell (e.g., number and locations of people within the unit cell, locations of furnishings within the unit cell, number and locations of machines, carts, and/or automated machines within the unit cell) as input. In some cases, a deep learning process may utilize an autoencoder neural network to identify more relevant and less relevant features from data that is input to the deep learning process. In other cases, a deep learning process may use a convolutional neural network.

By employing a deep learning process or other machine learning process, the processor's accuracy in determining tag location in a multipath environment can improve compared to a process based on trilateration or triangulation. In some cases, the accuracy to estimating tag location may improve to the extent that signals received from only one or two of the RFID readers 150 may be sufficient to update reference vectors Vᵣⱼ and/or estimate the location of an RFID tag to within an acceptable margin of error (e.g., within 50 cm). Therefore, interrogation and processing of reply signals may be decreased appreciably. Such a reduction of the number of tag interrogations and reply signals to be processed may result in a significant reduction of RFID readers 150 within a unit cell 410 (e.g., from eight or more to one or two) and a corresponding significant reduction in tag interrogations and signals to be processed. However, a machine learning process or deep learning process using inputs from only two RFID readers may require more training data, initially take more time to train, and may take longer to compute tag location than a machine learning or deep learning process that uses inputs from more RFID readers.

For some implementations, machine learning and/or deep learning may be used for a portion of the data obtained or derived from tag reply signals. At least one different analysis may be performed and used to determine tag location along with output from the machine learning or deep learning process. For example, machine learning and/or deep learning may be used to analyze multipath angular signal profiles 310 obtained by one or more of the tag readers 150 in a unit cell 410 and/or to analyze IQ signals from antenna elements as described above. Additionally, trilateration calculations may be performed based on RSSIs from two or more RFID readers and/or triangulation calculations may be performed based, at least in part, on AoAs from one or more readers. Results from the different calculations can be processed to estimate tag location. For example, each calculation may output an estimated location of the tag and the final estimate may be a weighted average of the locations. Accordingly, different data inputs and different analyses of the data can be used to improve the accuracy of estimating tag locations by the tag-locating system 400.

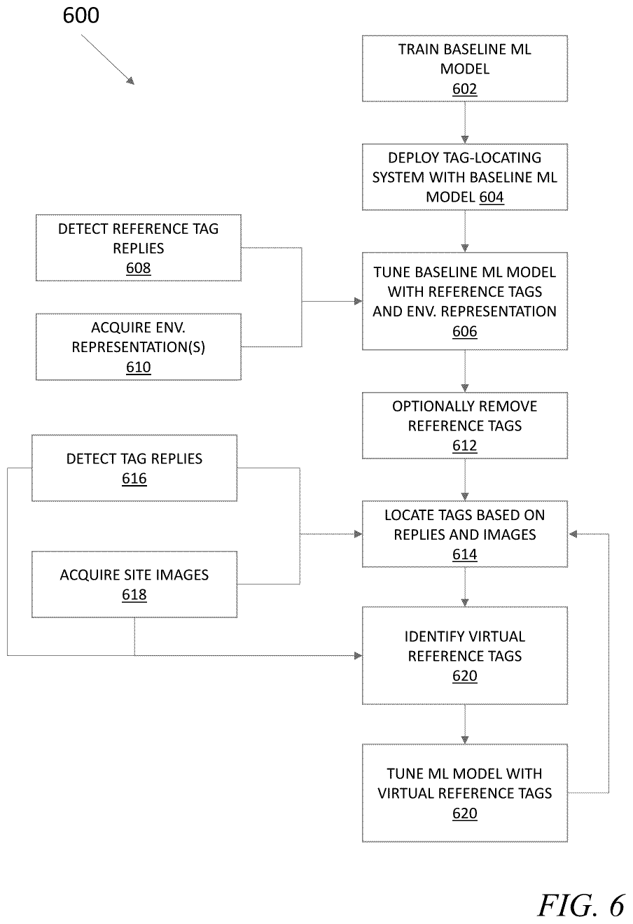

FIG. 6 illustrates a process 600 for deploying and using a tag-locating system and machine learning (ML) model as described above with respect to FIG. 4. As discussed above, the machine learning model can be a deep learning model, such as a multi-layer artificial neural network. As understood by those of skill in the art of artificial neural networks, an artificial neural network includes an input layer, one or more hidden layers, and an output layer, each of which includes one or more artificial neurons, or nodes. In a fully connected neural network, each node in each hidden layer is connected to one or more nodes in the immediately preceding layer and immediately following layer and has an associated weight and nonlinearity (e.g., a rectified nonlinearity unit (ReLU) nonlinearity). A given node weights and sums its inputs, then applies the nonlinearity to the weighted sum and passes the result to the nodes in the next layer. The nodes in the output layer provide their outputs as the output of the neural network. Other suitable deep learning models include convolutional neural networks and transformers.

The baseline neural network or machine learning model for the tag-locating system is trained using a large set of training data generated from hundreds to thousands of reference tags at known locations in a well-understood multipath environment with several readers (602).

Generally, training involves collecting signal vectors (or signatures) for the reference tags, which are at known positions. If there are N reference tags, each with M antenna elements, the collection of signatures effectively includes NM complex channel estimates. Readers collect those complex channel estimates over as many sets of parameters (e.g., different carrier frequencies, beam-forming sectors, etc.) as possible (e.g., a reference tag is read on 50 RFID channels (carrier frequencies) by each of three different sensors).

More specifically, consider training a k nearest neighbor model as a baseline machine learning model for locating RFID tags. The reference tags are arranged with reference panels in a grid pattern (e.g., spaced 15 cm) in the training environment, and the readers in the training environment acquire signatures for each tag, where each signature is the feature or signal vector produced for a given combination of sensor, beam-forming sector, carrier frequency, and tag position. The signatures are stored in a signature table in a non-volatile memory that is in or operably coupled to the appliance.

Still in the training environment, the reference panels are replaced with RFID tags attached to commercial products or other objects. The readers interrogate the RFID tags attached to the commercial products or other objects at different carrier frequencies and beam-forming sectors. For each combination of RFID tag, reader, beam-forming sector, and carrier frequency, the appliance pulls the corresponding entries from the signature table and using a nearest-neighbor search over the signatures (feature/signal vectors) to find the k nearest neighbors. The appliance computes the weighted average of the locations of the k nearest neighbors and returns the weighted average as the estimated location of the RFID tag in question. Once trained, deployed, and tuned, the appliance follows a similar process for locating tags at the installation site/multipath environment.

The training data can include, but is not limited to, replies from the reference tags, measures derived from the replies, and the reference tags' positions relative to the readers that sense the replies. The training data also includes information about the multipath environment, including but not limited to floorplans, lidar scans, images, or other representations of the multipath environment. Floorplans, lidar scans, images, and other representations illustrate the locations of walls, shelves, tables, cash registers, and other fixed objects that can scatter, absorb, attenuate, or disperse the replies. Images also illustrate people and objects that can move through the multipath environment and scatter, absorb, attenuate, or disperse the replies. Other training data includes information about the readers that sense the replies, including the readers' locations (e.g., heights and lateral coordinates), antenna orientations, beam forming sectors, interrogation signal strengths and carrier frequencies, and whether a given reader is in interrogator or listening mode when it senses a reply. This training can be carried out on-demand or well before installation and deployment of the tag-locating system are even contemplated.

Once the baseline machine learning model has been trained, it can be deployed to an installed tag-locating system (604). Deployment can occur as part of the process of installing the tag-locating system, e.g., as described in International Application No. PCT/US2023/068002, filed Jun. 6, 2023, and entitled “Deploying RFID Readers in Environments Having a Dense Population of RFID Tags,” which is incorporated herein by reference in its entirety for all purposes. Deployment can also occur after the tag-locating system has been installed and been operating for a period of time, e.g., if the baseline machine learning model represents an improvement thanks to improvements in the model architecture or performance improvements due to additional training.

During or after deployment, the baseline machine learning model is tuned (606) with training data in the form of tag replies (608) acquired in and images, lidar scans, floorplans, or other representations (610) of the multipath environment where the tag-locating system is installed (the installation site). Tuning accounts for differences between the installation site and the environment in which the baseline machine learning model was trained, including differences in reader locations and multipath effects due to different walls, fixtures, etc. Tuning involves transfer learning, where the baseline machine learning model is used as the starting point for a addressing a new problem-locating RFID tags at the installation site (as opposed to in the training environment). The training set for transfer learning can be relatively small, e.g., it may include replies (608) detected from just a dozen or so reference RFID tags placed at known locations at the installation site and interrogated by each of the tag-locating system's sensors. The training data for transfer learning can also include (1) floorplans, lidar scans, images, and other representations of the training site that illustrate the locations of people, walls, shelves, tables, cash registers, etc. and (2) information about the readers that sense the replies, including the readers' locations (e.g., heights and lateral coordinates), antenna orientations, beam forming sectors, interrogation signal strengths and carrier frequencies, and whether a given reader is in interrogator or listening mode when it senses a reply. The representations of the training site can be acquired (610) with the tag-locating system's cameras, a separate camera, a portable lidar scanner, or another suitable sensor.

For a baseline neural network with multiple hidden layers, tuning may involve freezing the weights of the nodes in the lower-level hidden layers (i.e., the hidden layers closer to the input) and adjusting the weights of the nodes in the higher-level hidden layers (i.e., the hidden layers closer to the output). Alternatively, or in addition, the nodes in the different hidden layers can have different learning rates, with nodes in the lower-level hidden layers having relatively slow learning rates and the nodes in the higher-level hidden layers having faster learning rates. Using variable learning rates works very well for training the baseline neural network with a large training set in a well-known training environment (602) and tuning the neural network once it has been deployed to the installation site (606).

Once the machine learning model has been tuned with the reference RFID tags, the reference RFID tags can be removed from the multipath environment (612), e.g., for use in tuning a machine learning model at a different installation site. The reference RFID tags can also be left in place for subsequent tuning. For instance, the reference RFID tags can be queried or interrogated in response to movement of fixtures into, out of, or within the multipath environment for tuning the machine learning model to account for the fixture movement. Likewise, the reference RFID tags can be queried or interrogated in response to changes in the sensors' operating parameters or positions. The reference RFID tags can also be moved to and interrogated in other (known) positions within the multipath environment to provide a more diverse set of data for tuning the machine learning model.

Whether or not the reference RFID tags remain in the multipath environment, the tag-locating system can use the tuned machine learning model to locate RFID tags at unknown locations within the multipath environment (614). In operation, the tag-locating system detects tag replies with the readers (616) and images with the cameras (618) and supplies this information (or measures derived from this information) along with information about or form the readers themselves (e.g., interrogation signal carrier frequency and power level and antenna beam-forming sector) to the appliance running the machine learning model. The machine learning model uses this information as well as prior knowledge, such as lidar scans of the installation site, to estimate the locations of the corresponding RFID tags.

At the same time, the appliance tunes the machine learning model with one or more virtual reference RFID tags, also called virtual reference tag (620). A virtual reference tag is an RFID tag whose location is not predefined or predetermined but is verified using sensing modalities, such as computer vision, independent of the replies sensed by the readers. For example, if one of the tag-locating system's camera acquires an image of an object known to be attached to a particular RFID tag, and the appliance or another processor operably coupled to camera derives the object's location from the image, the RFID tag's location can be matched or assigned to the object's location. Similarly, if the camera detects a person carrying the object and RFID tag, the appliance can automatically estimate the person's location and match or attribute the RFID tag's location to the person's location. The appliance can identify virtual reference tags and their locations (620) and use them to tune the machine learning model as the tag-locating system operates. This continuously running tuning process can occur without human intervention and enables to machine learning model to refines the accuracy of its location estimates and to accommodate changes in the multipath environment, e.g., due to movement of people, objects, and/or tags.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the components so conjoined, i.e., components that are conjunctively present in some cases and disjunctively present in other cases. Multiple components listed with “and/or” should be construed in the same fashion, i.e., “one or more” of the components so conjoined. Other components may optionally be present other than the components specifically identified by the “and/or” clause, whether related or unrelated to those components specifically identified. Thus, as a non-limiting example, a reference to “A and/or B”, when used in conjunction with open-ended language such as “comprising” can refer, in one embodiment, to A only (optionally including components other than B); in another embodiment, to B only (optionally including components other than A); in yet another embodiment, to both A and B (optionally including other components); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of components, and, optionally, additional unlisted items. Only terms clearly indicated to the contrary, such as “only one of” or “exactly one of,” or, when used in the claims, “consisting of,” will refer to the inclusion of exactly one component of a number or list of components. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more components, should be understood to mean at least one component selected from any one or more of the components in the list of components, but not necessarily including at least one of each and every component specifically listed within the list of components and not excluding any combinations of components in the list of components. This definition also allows that components may optionally be present other than the components specifically identified within the list of components to which the phrase “at least one” refers, whether related or unrelated to those components specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including components other than B); in another embodiment, to at least one, optionally including more than one, B, with no A present (and optionally including components other than A); in yet another embodiment, to at least one, optionally including more than one, A, and at least one, optionally including more than one, B (and optionally including other components); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for locating a first radio-frequency identification (RFID) tag in a multipath environment, the method comprising:
receiving, by an RFID reader located at a first position in the multipath environment, a reply signal by the first RFID tag sent in response to an interrogation of the first RFID tag, the reply signal being representative of the multipath environment;
obtaining a representation of the multipath environment;
constructing, by a processor in communication with the first RFID reader, a signal vector based, at least in part, on the reply signal;
providing the signal vector and the representation of the multipath environment as input to a machine learning process that executes on the processor, wherein the machine learning process is trained with reference signals received from RFID reference tags and at least one previously obtained representation of the multipath environment;
estimating, with the machine learning process from the input, a location of the first RFID tag in the multipath environment; and
outputting, from the machine learning process, the location of the first RFID tag.

2. The method of claim 1, wherein the input comprises at least one element based on information derived from in-phase and in-quadrature waveforms obtained from the reply signal received by the first RFID reader.

3. The method of claim 1, wherein the input comprises at least one element based on information derived from a multipath angular signal profile.

4. The method of claim 1, wherein the input comprises at least one element based on received signal strength or differential phase delay of a radio-frequency carrier wave of the reply signal.

5. The method of claim 1, wherein the RFID reader is a first RFID reader, the location is a first location, and further comprising:
determining, by the processor, an angle of arrival (AoA) of the reply signal at the first RFID reader;
detecting, by a second RFID reader located at a second position in the multipath environment, the reply signal sent by the first RFID tag in response to the interrogation of the first RFID tag;
determining, by the processor, an AoA of the reply signal at the second RFID reader;
estimating, by the processor, a second location of the first RFID tag using the AoA of the reply signal at the first RFID reader and the AoA of the reply signal at the second RFID reader;
estimating a third location of the first RFID tag that is based on the first location and the second location; and
outputting, by the processor, the third location as an estimated location of the first RFID tag.

6. The method of claim 1, wherein obtaining the representation of the multipath environment comprises acquiring at least one image of the multipath environment with a camera.

7. The method of claim 1, wherein obtaining the representation of the multipath environment comprises performing at least one lidar scan of the multipath environment.

8. The method of claim 1, wherein the RFID reference tags are not present in the multipath environment when the estimating is performed.

9. The method of claim 1, wherein the first RFID tag is attached to a commercial product for product identification and/or product tracking.

10. The method of claim 1, wherein the RFID reference tags are spaced more than 15 centimeters apart and an accuracy of the location for the first RFID tag is less than one meter.

11. The method of claim 1, further comprising:
identifying, by the processor, at least one region in the multipath environment where the first RFID tag can be located; and
rejecting an estimated location of the first RFID tag that falls outside the at least one region.

12. The method of claim 1, further comprising:
identifying, by the processor, an excluded region in the multipath environment where the first RFID tag is not located; and
rejecting an estimated location of the first RFID tag that falls within the excluded region.

13. The method of claim 12, wherein the identifying comprises:
analyzing, by the processor, the representation of the multipath environment to identify the excluded region as a region where an RFID tag cannot be physically located.

14. The method of claim 12, wherein the identifying comprises:
analyzing, by the processor, the representation of the multipath environment to identify the excluded region as an aisle or open space where RFID tags are not normally located.

15. The method of claim 1, further comprising:
analyzing, by the processor, the representation of the multipath environment to identify an excluded region as an aisle or open space where RFID tags are not normally located;
determining that the location of the first RFID tag falls within the excluded region;
analyzing, by the processor, an image of the excluded region captured concurrently with the reply signal to determine whether a person, cart, or machine that can transport the first RFID tag is present at the excluded region; and
outputting the location of the first RFID tag in response to determining that the person, cart, or machine is present at the excluded region.

16. The method of claim 1, wherein the RFID reader is a first RFID reader that listens for the reply signal and a second RFID reader spaced apart from the first RFID reader performs the interrogation of the first RFID tag.

17. The method of claim 1, further comprising:
receiving, by the processor, an actual location of the first RFID tag; and
tuning the machine learning process using the input and the actual location of the first RFID tag.

18. The method of claim 1, further comprising:
detecting, by a second RFID reader located at a second position in the multipath environment, the reply signal from the first RFID tag in response to the interrogation of the first RFID tag,
wherein the input is further based on the reply signal as detected by the second RFID reader.

19. The method of claim 1, further comprising:
analyzing, by the processor, one or more images of the multipath environment to determine whether a furnishing supporting the first RFID tag has been moved within the multipath environment;
determining from the one or more images a new location and/or orientation of the furnishing; and
tuning, by the processor, the machine learning process based on the one or more images of the multipath environment in response to determining the new location and the orientation of the furnishing.

20. The method of claim 1, further comprising, before receiving the reply signal by the first RFID tag sent in response to the interrogation of the first RFID tag:
distributing the RFID reference tags in known locations in a training environment;
receiving the reference signals from the RFID reference tags;
training the machine learning process with the reference signals; and
deploying the machine learning process to the multipath environment.

21. A tag-locating system comprising:
radio-frequency identification (RFID) readers adapted to be mounted at respective locations in a multipath environment containing RFID tags and adapted to interrogate the RFID tags, the RFID readers including a first RFID reader to receive a reply from a first RFID tag of the RFID tags in response to an interrogation of the first RFID tag; and
a processor in communication with the RFID readers and adapted to execute a machine learning process to estimate a location of a first RFID tag of the RFID tags within the multipath environment, wherein the processor, when operating, is adapted with code to:
construct a signal vector based, at least in part, on the reply from the reply from the first RFID tag received by the first RFID reader;
provide the signal vector as input to the machine learning process, wherein the machine learning process is trained with reference vectors constructed from reference signals received from RFID reference tags distributed in the multipath environment;
estimate, with the machine learning process from the signal vector, the location of the first RFID tag in the multipath environment; and
output, from the machine learning process, the location of the first RFID tag.

22. The tag-locating system of claim 21, wherein at least one of the RFID readers comprises an antenna array having a plurality of antenna elements.

23. The tag-locating system of claim 21, wherein a density of the RFID readers in the multipath environment is a value from 0.001 m⁻³ to 0.1 m⁻³.

24. The tag-locating system of claim 21, wherein the machine learning process is trained with the RFID reference tags having a density value in the multipath environment from 0.01 m⁻³ to 10 m⁻³.

25. The tag-locating system of claim 21, wherein an accuracy in estimating the location is less than one meter.

26. The tag-locating system of claim 21, wherein the RFID reference tags are not present in the multipath environment when the estimating is performed.

27. The tag-locating system of claim 21, further comprising:
one or more cameras each arranged to capture one or more images of at least portions of the multipath environment, wherein the processor is further adapted to:
identifying, from the one or more images of the multipath environment captured by the one or more cameras, at least one region in the multipath environment where the first RFID tag can be located; and
reject an estimated second location of the first RFID tag that falls outside the at least one region.

28. A method for locating a radio-frequency identification (RFID) tag in a multipath environment, the method comprising:
receiving, by an n-element antenna array, a reply from the RFID tag, where n is an integer greater than 1;
constructing, by a processor in communication with the n-element antenna array, a signal vector based on the reply from the RFID tag;
obtaining, with a camera, an image of the multipath environment;
providing the signal vector and the image as input to a machine learning model executing on the processor, wherein the machine learning model is trained with reference vectors constructed from reference signals received from RFID reference tags at respective known locations;
estimating, with the machine learning model based on the signal vector and the image, a location of the RFID tag in the multipath environment; and
outputting, from the machine learning model, the location of the RFID tag.

29. The method of claim 28, wherein the signal vector comprises n complex numbers, wherein each of the n complex numbers represents an estimate of a communications channel between the RFID tag and a corresponding antenna element in the n-element antenna array.

30. The method of claim 28, wherein the RFID tag is a first RFID tag, the signal vector is a first signal vector, and further comprising:
obtaining, with the camera, an image of a second RFID tag;
determining a location of the second RFID tag from the image of the second RFID tag;
receiving, by the n-element antenna array, a reply from the second RFID tag;
constructing, by the processor, a second signal vector based on the reply from the second RFID tag; and
tuning the machine learning model based on the second signal vector and the location of the second RFID tag.
